(19) United States
(12) Patent Application Publication
(10) Pub. No.: US 2009/0245528 A1
(43) Pub. Date: Oct. 1, 2009

(54) METHOD FOR REDUCING ECHO AND RELATED ECHO REDUCING DEVICE AND VOICE APPARATUS THEREOF

(76) Inventors: Ter-Ming Tang, Taipei City (TW); Shi-En Wang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/056,263

(22) Filed: Mar. 26, 2008

(51) Int. Cl. H04B 3/20

(52) U.S. Cl. 381/66

(57) ABSTRACT

A method for reducing echo includes detecting whether an output sound volume is greater than a threshold value, and setting an input sensitivity from a first designated sensitivity value to a second designated sensitivity value when the output sound volume is detected to be greater than the threshold value. The method further includes detecting whether an interrupt signal is received, determining whether the interrupt signal is triggered by detecting that the output sound volume is greater than the threshold value when receiving the interrupt signal, detecting whether the input sensitivity is the second designated sensitivity value when determining that the interrupt signal is triggered by detecting that the output sound volume is greater than the threshold value, and setting the input sensitivity as the second designated sensitivity value when detecting that the input sensitivity is not the second designated sensitivity value.

### BACKGROUND OF THE INVENTION

1. Field of the Invention

The present invention relates to a method for reducing echo and a related echo reducing device and voice apparatus, and more particularly, to a method and related apparatus for reducing echo through dynamically adjusting the sensitivity of a sound input device according to an output sound volume.

2. Description of the Prior Art

With the popularity of consumer electronic products, such as mobile phones, ease of communication has exponentially increased and distances between human beings have been effectively shortened. Many kinds of communication devices (such as mobile phones, car phones, and Bluetooth devices) include hands-free functions, thus users can communicate without physically holding the telephone transmitters or headphones close to their ears, which can decrease the potential for damage due to excessive noise, and further achieve a goal of multi-user communication. The echo issue, however, is a resultant problem that occurs in telephone voice processing.

In the prior art, the conventional echo reducing technologies such as hardware machinery, software calculation, and dedicated processing chips are usually adopted to deal with this echo issue. These three conventional solutions can be arbitrarily combined or can simultaneously exist for improving the effect of processing echoes. Nevertheless, no matter what combinations are in effect, each issue immediately appears if the sound volume is too large. In other words, no matter how these three conventional solutions are combined, there is still an upper limit on sound volume. Furthermore, consumer electronic products are unable to restrict consumers' usage and thus the effectiveness of echo reduction cannot be guaranteed.

### SUMMARY OF THE INVENTION

It is one of the objectives of the present invention to provide a method for reducing echo and a related echo reducing device and voice apparatus that detects an output sound volume to dynamically adjust a sensitivity of the sound input device in order to solve the abovementioned problems.

The present invention provides a method for reducing echo. The method includes detecting whether an output sound volume is greater than a threshold value, and setting an input sensitivity from a first designated sensitivity value to a second designated sensitivity value when the output sound volume is detected to be greater than the threshold value.

The present invention further provides an echo reducing device. The echo reducing device includes a sound volume detecting module, and a sensitivity setting module. The sound volume detecting module is used for detecting whether an output sound volume is greater than a threshold value. The sensitivity setting module is coupled to the sound volume detecting module for setting an input sensitivity from a first designated sensitivity value to a second designated sensitivity value when the output sound volume is detected to be greater than the threshold value. The sensitivity setting module is a micro-processing control unit, and the sound volume detecting module is an analog-to-digital converter. The analog-to-digital converter can be disposed outside or inside the micro-processing control unit.

The present invention further provides a voice apparatus. The voice apparatus includes a sound output module, a sound input module, a sound volume detecting module and a sensitivity setting module. The sound output module outputs an output sound volume, and the sound input module has an input sensitivity. The sound volume detecting module is used for detecting whether the output sound volume is greater than a threshold value. The sensitivity setting module is coupled to the sound volume detecting module and the sound input module for setting the input sensitivity of the sound input module from a first designated sensitivity value to a second designated sensitivity value when the output sound volume is detected to be greater than the threshold value. The sound output module is a speaker, and the input module is a microphone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a voice apparatus capable of reducing echo according to a first embodiment of the present invention.

FIG. 2 is a diagram showing a circuit architecture of the echo reducing device shown in FIG. 1 according to an embodiment of the present invention.

FIG. 3 is a flowchart illustrating a method for reducing echo according to an exemplary embodiment of the present invention.

FIG. 4 (including 4A and 4B) is a diagram showing operations of the threshold value generator in FIG. 2 for measuring the relationship between the input sensitivity and the echo.

FIG. 5 is a flowchart illustrating an operation process of how the threshold value generator shown in FIG. 2 determines the threshold value.

FIG. 6 is a diagram of a voice apparatus capable of reducing echo according to a second embodiment of the present invention.

FIG. 7 is a diagram showing a circuit architecture of the echo reducing device shown in FIG. 6 according to an embodiment of the present invention.

FIG. 8 is a flowchart illustrating a method for reducing echo according to another exemplary embodiment of the present invention.

### DETAILED DESCRIPTION

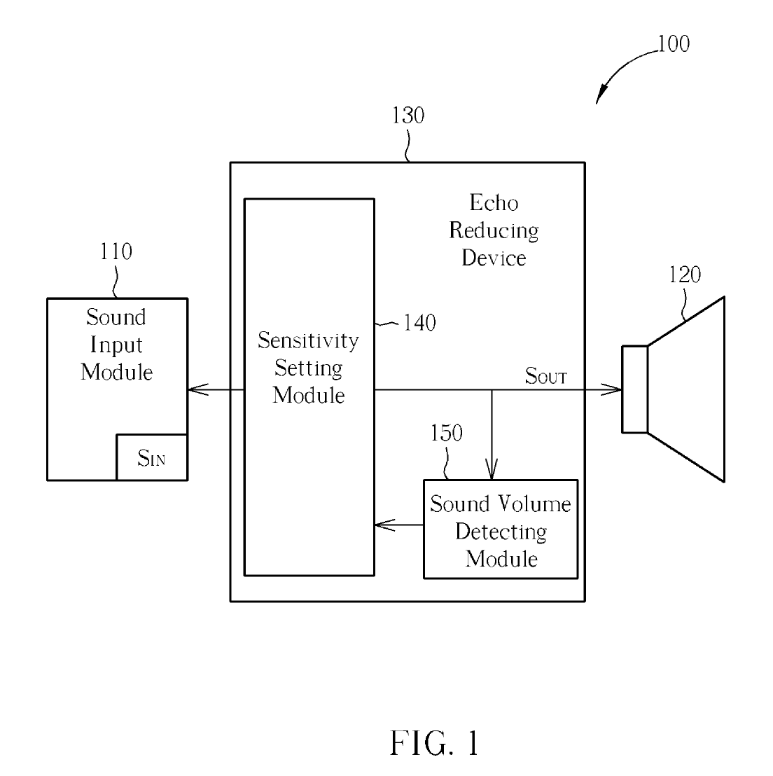

Please refer to FIG. 1. FIG. 1 is a diagram of a voice apparatus 100 capable of reducing echo according to a first embodiment of the present invention. The voice apparatus 100 includes a sound input module 110, a sound output module 120, and an echo reducing device 130. The sound input module 110 has an input sensitivity S_{IN}, and the sound output module 120 is used for outputting an output sound volume S_{OUT}. The echo reducing device 130 includes a sensitivity setting module 140 and a sound volume detecting module 150. The sound volume detecting module 150 is coupled between the sound output module 120 and the sensitivity setting module 140 for detecting whether the output sound volume S_{OUT} is greater than a threshold value TH₁. The sensitivity setting module 140 is coupled to the sound output module 120, the sound volume detecting module 150, and the sound input module 110, for setting the input sensitivity S_{IN} of the sound input module 110 from a first designated sensitivity value S1 to a second designated sensitivity value S2 when the output sound volume S_{OUT} is detected to be greater than the threshold value TH₁. Further descriptions of the elements and operations of the echo reducing device 130 are detailed in the following embodiments below.

Please note that the abovementioned voice apparatus 100 can be a Bluetooth hands-free device, a car phone, or a mobile phone, but this is not a limitation of the present invention and the voice apparatus 100 can be a voice apparatus of a different type. In one embodiment, the sound output module 120 can be a speaker, but this is presented merely for illustrating examples of the present invention, and should not be considered as a limitation of the present invention. In addition, the sound input module 110 can be a microphone, but this is not a limitation of the present invention and the sound input module 110 can be implemented by other sound input elements. Please also note that the sensitivity setting module 140 can be implemented by a micro-processing control unit but is not limited to this only. The sound volume detecting module 150 can be implemented by an analog-to-digital converter, which is disposed outside the sensitivity setting module 140 (which can be implemented by the micro-processing control unit). Those skilled in the art should appreciate that these modifications should not be considered to be limitations of the scope of the present invention.

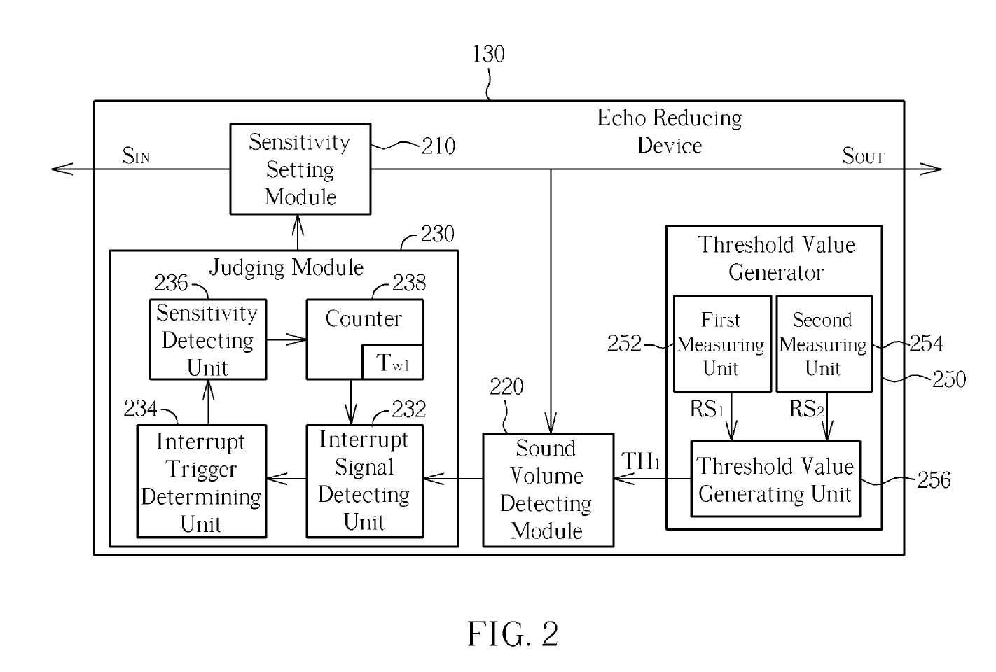

Please refer to FIG. 2. FIG. 2 is a diagram showing a circuit architecture of the echo reducing device 130 shown in FIG. 1 according to an embodiment of the present invention. In this embodiment, the echo reducing device 130 includes, but is not limited to, a sensitivity setting module 210, a sound volume detecting module 220, a judging module 230, and a threshold value generator 250. The sound volume detecting module 220 is coupled between the judging module 230 and the threshold value generator 250 for detecting whether the output sound volume S_{OUT} is greater than the threshold value TH₁. The judging module 230 is coupled between the sound volume detecting module 220 and the sensitivity setting module 210. In this embodiment, the judging module 230 includes an interrupt signal detecting unit 232, an interrupt trigger determining unit 234, a sensitivity detecting unit 236, and a counter 238. The interrupt signal detecting unit 232 is coupled to the sound volume detecting module 220 and the counter 238 for detecting whether an interrupt signal ITR₁ is received. The interrupt trigger determining unit 234 is coupled to the interrupt signal detecting unit 232 for determining which event the interrupt signal ITR₁ is triggered by (for example, the interrupt signal ITR₁ is triggered by detecting that the output sound volume S_{OUT} is greater than the threshold value TH₁ or that a waiting time T_{W1} is exceeded) when receiving the interrupt signal ITR₁. The counter 238 is coupled to the sensitivity detecting unit 236 for counting the waiting time T_{W1}. The sensitivity detecting unit 236 is coupled to the interrupt trigger determining unit 234 and the counter 238 for detecting whether the input sensitivity S_{IN} is the second designated sensitivity value S2, and for resetting the waiting time T_{W1} when determining that the input sensitivity S_{IN} is the second designated sensitivity value S2. The sensitivity setting module 210 is coupled to the judging module 230 for setting the input sensitivity S_{IN} of the sound input module 110 (please refer to FIG. 1) according to the detecting result of the sound detecting module 220 and the judgment result of the judging module 230.

Please keep referring to FIG. 2. In this embodiment, the threshold value generator 250 includes a first measuring unit 252, a second measuring unit 254, and a threshold value generating unit 256. The first measuring unit 252 maintains the input sensitivity S_{IN} at a fixed sensitivity and then measures a first relationship RS₁ between the output sound volume S_{OUT} and an echo EC₁. The second measuring unit 254 maintains the output sound volume S_{OUT} at a fixed sound volume and then measures a second relationship RS₂ between the input sensitivity S_{IN} and the echo EC₁. The threshold value generating unit 256 is coupled to the first measuring unit 252 and the second measuring unit 254 for generating the threshold value TH₁ according to the first relationship RS₁ and the second relationship RS₂. Please note that the circuit architecture of the abovementioned threshold value generator 250 is merely an embodiment of the present invention, and should not be considered to be a limitation of the scope of the present invention. Those skilled in the art should appreciate that various modifications of the threshold value generator 250 may be made without departing from the spirit of the present invention.

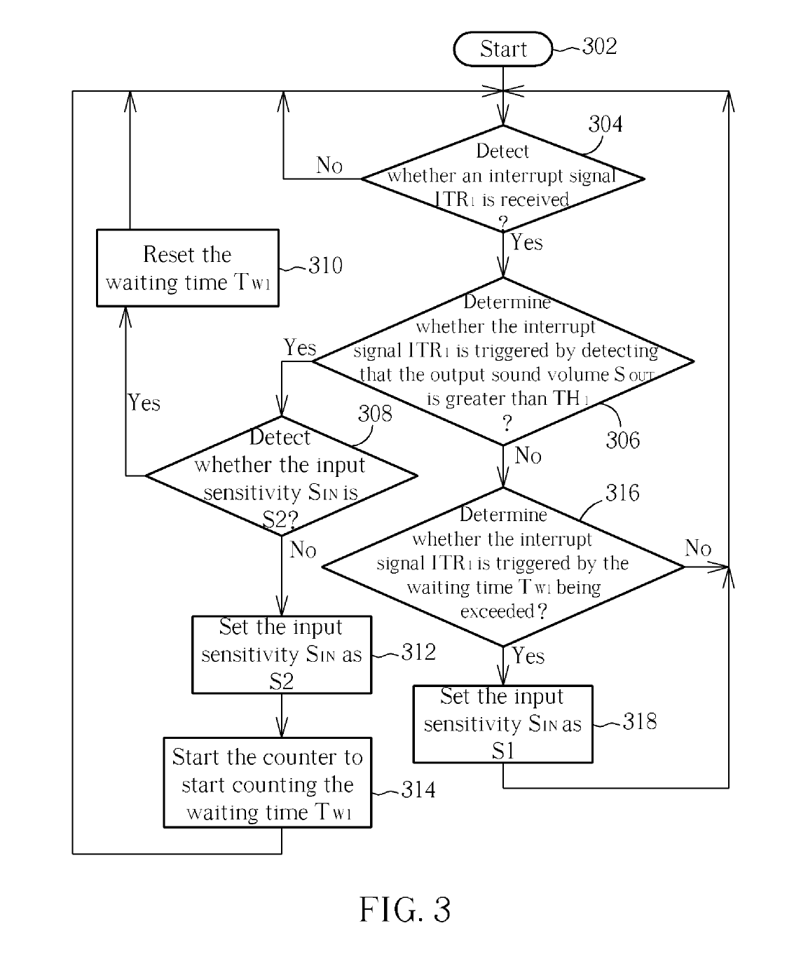

Please refer to FIG. 3. FIG. 3 is a flowchart illustrating a method for reducing echo according to an exemplary embodiment of the present invention. Please note that the following steps are not limited to be performed according to the exact sequence shown in FIG. 3 if a roughly identical result can be obtained. The method includes the following steps:

Step 302: Start;

Step 304: Detect whether an interrupt signal ITR₁ is received. If the interrupt signal ITR₁ is received, go to Step 306; otherwise, go back to Step 304 to continue detecting;

Step 306: Determine whether the interrupt signal ITR₁ is triggered by detecting that the output sound volume S_{OUT} is greater than the threshold value TH₁. If the interrupt signal ITR₁ is triggered by detecting that the output sound volume S_{OUT} is greater than the threshold value TH₁, go to Step 308; otherwise, go to Step 316;

Step 308: Detect whether the input sensitivity S_{IN} is the second designated sensitivity S2. When the input sensitivity S_{IN} is detected to be the second designated sensitivity S2, go to Step 310; otherwise, go to Step 312;

Step 310: Reset the waiting time T_{W1};

Step 312: Set the input sensitivity S_{IN} as the second designated sensitivity S2;

Step 314: Start the counter to start counting the waiting time T_{W1};

Step 316: Determine whether the interrupt signal ITR₁ is triggered by the waiting time T_{W1} being exceeded. If the interrupt signal ITR₁ is triggered by the waiting time T_{W1} being exceeded, go to Step 318; otherwise, go back to Step 304;

Step 318: Set the input sensitivity S_{IN} as the first designated sensitivity S1.

The following description details how each element operates by collocating the steps shown in FIG. 3 and the elements shown in FIG. 1 and FIG. 2. In Step 304, the interrupt signal detecting unit 232 of the judging module 230 detects whether the interrupt signal ITR₁ is received. If the interrupt signal ITR₁ is not received, the interrupt signal detecting unit 232 continues detecting (return to Step 304). If the interrupt signal ITR₁ is received, the interrupt trigger determining unit 234 determines whether the interrupt signal ITR₁ is triggered by detecting that the output sound volume S_{OUT} is greater than the threshold value TH₁ (Step 306). In the following, the steps in FIG. 3 are divided into two conditions for detail descriptions.

Under the first condition, if the interrupt signal ITR₁ is triggered by detecting that the output sound volume S_{OUT} is greater than the threshold value TH₁, the sensitivity detecting unit 236 detects whether the input sensitivity S_{IN} is the second designated sensitivity S2 (Step 308). When the input sensitivity S_{IN} is the second designated sensitivity S2, the sensitivity detecting unit 236 then notifies the counter 238 to reset the waiting time T_{W1} (Step 310). When the input sensitivity S_{IN} is not the second designated sensitivity S2, the sensitivity setting module 210 sets the input sensitivity S_{IN} as the second designated sensitivity S2 (Step 312) and the sensitivity detecting unit 236 starts the counter 238 to start counting the waiting time T_{W1} (Step 314).

Under the second condition, if the interrupt signal ITR₁ is not triggered by detecting that the output sound volume S_{OUT} is greater than the threshold value TH₁, the interrupt trigger determining unit 234 then determines whether the interrupt signal ITR₁ is triggered by the waiting time T_{W1} being exceeded (Step 316). If the interrupt signal ITR₁ is triggered by the waiting time T_{W1} being exceeded, the sensitivity setting module 210 then sets the input sensitivity S_{IN} as the first designated sensitivity S1 (Step 318). On the other hand, if the interrupt signal ITR₁ is not triggered by the waiting time T_{W1} being exceeded, the interrupt signal detecting unit 232 continues detecting (go back to Step 304).

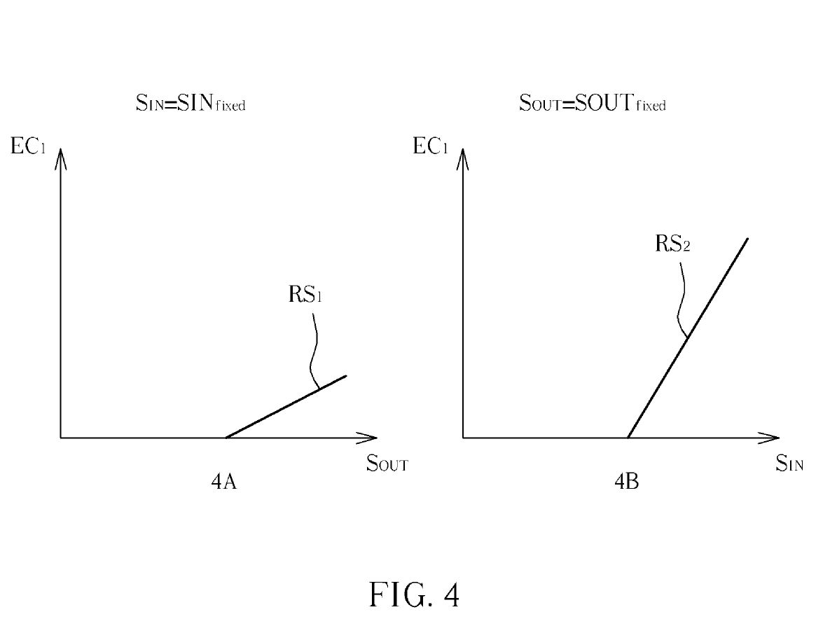

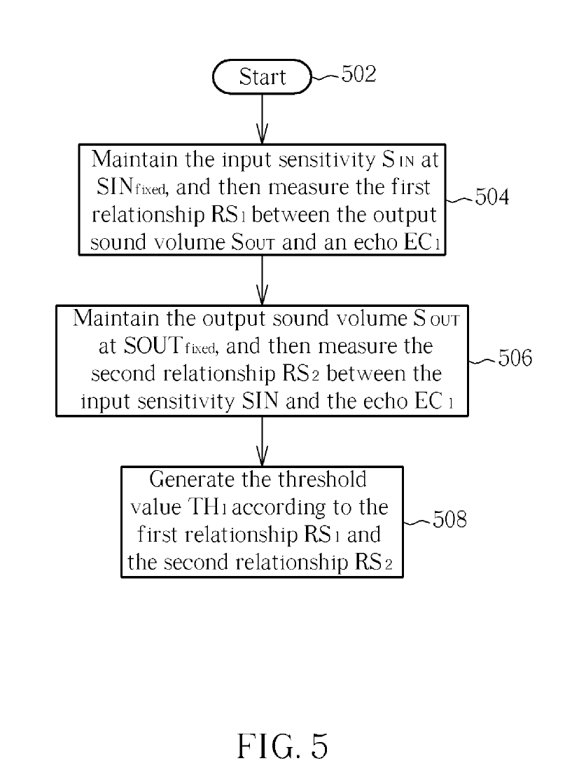

Please refer to FIG. 4 together with FIG. 5. FIG. 4 (including 4A and 4B) is a diagram showing operations of the threshold value generator 250 in FIG. 2 for measuring the relationship between the input sensitivity S_{IN} and the echo EC₁. FIG. 5 is a flowchart illustrating an operation process of how the threshold value generator 250 shown in FIG. 2 determines the threshold value TH₁. As shown in 4A, the first measuring unit 252 of the threshold value generator 250 maintains the input sensitivity S_{IN} at a fixed sensitivity SIN_{fixed} and then measures the first relationship RS₁ between the output sound volume S_{OUT} and an echo EC₁. As shown in 4B, the second measuring unit 254 of the threshold value generator 250 maintains the output sound volume S_{OUT} at a fixed sound volume SOUT_{fixed} and then measures the second relationship RS₂ between the input sensitivity S_{IN} and the echo EC₁. The method in FIG. 5 includes the following steps:

Step 502: Start;

Step 504: Maintain the input sensitivity S_{IN} at a fixed sensitivity SIN_{fixed}, and then measure the first relationship RS₁ between the output sound volume S_{OUT} and an echo EC₁;

Step 506: Maintain the output sound volume S_{OUT} at a fixed sound volume SOUT_{fixed}, and then measure the second relationship RS₂ between the input sensitivity S_{IN} and the echo EC₁;

Step 508: Generate the threshold value TH₁ according to the first relationship RS₁ and the second relationship RS₂.

For the steps 502-508 shown in FIG. 5, the operations can be known by collating the elements shown in FIG. 2 and the embodiment shown in FIG. 4, and further description is therefore omitted here for brevity. Please note that the abovementioned threshold value generator 250 and flowchart are merely exemplary embodiments of the present invention, and in no way should be considered to be limitations of the scope of the present invention.

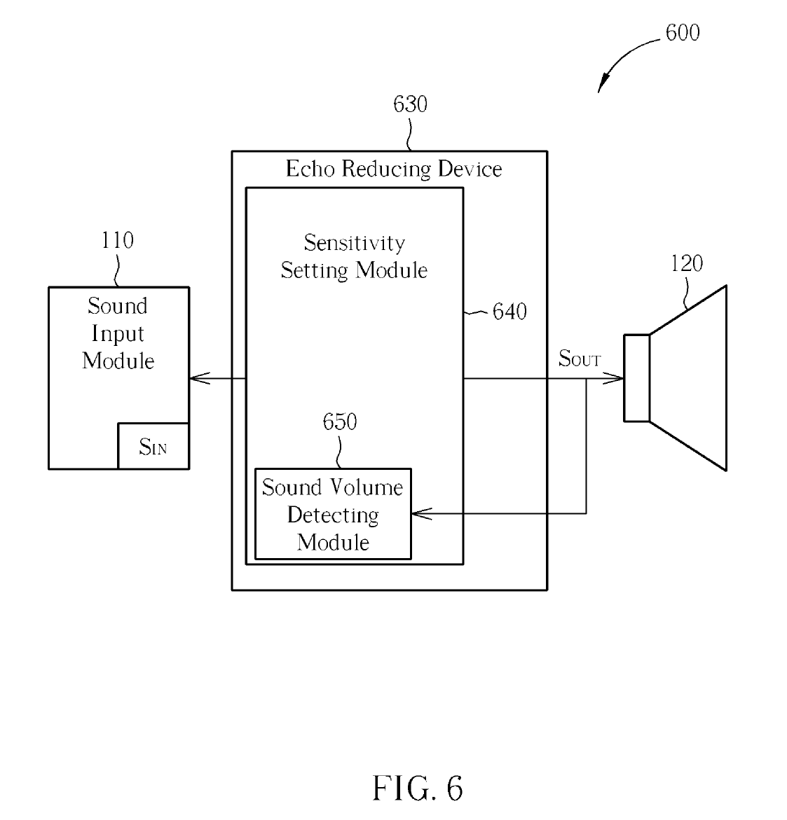

Please refer to FIG. 6. FIG. 6 is a diagram of a voice apparatus 600 capable of reducing echo according to a second embodiment of the present invention. The voice apparatus 600 is similar to the voice apparatus 100 shown in FIG. 1, where the difference between them is that a sound volume detecting module 650 of an echo reducing device 630 included in the voice apparatus 600 is disposed inside a sensitivity setting module 640, wherein the sensitivity setting module 640 can be implemented by a micro-processing control unit and the sound volume detecting module 650 can be implemented by an analog-to-digital converter, but is not limited to this only. Further descriptions of the elements and operations of the echo reducing device 630 are detailed in the following embodiments below.

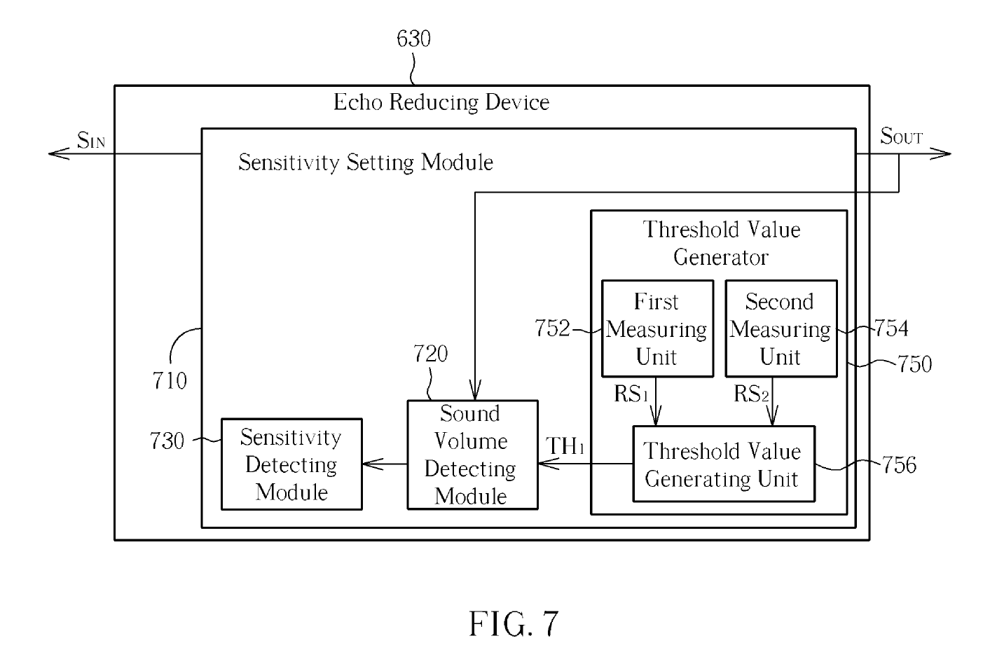

Please refer to FIG. 7. FIG. 7 is a diagram showing a circuit architecture of the echo reducing device 630 shown in FIG. 6 according to an embodiment of the present invention. In this embodiment, the echo reducing device 630 includes, but is not limited to, a sensitivity setting module 710, a sound volume detecting module 720, a sensitivity detecting module 730, and a threshold value generator 750, wherein the sound volume detecting module 720, the sensitivity detecting module 730, and the threshold value generator 750 are all disposed inside the sensitivity setting module 710. The sound volume detecting module 720 is coupled between the sensitivity detecting module 730 and the threshold value generator 750 for detecting whether the output sound volume S_{OUT} is greater than the threshold value TH₁. The sensitivity detecting module 730 is coupled to the sound volume detecting module 720 for determining whether the input sensitivity S_{IN} is the second designated sensitivity S2 when detecting that the output sound volume S_{OUT} is not greater than the threshold value TH₁ (i.e., S_{OUT}≦TH₁). When the input sensitivity S_{IN} is the second designated sensitivity S2, the sensitivity setting module 710 sets the input sensitivity S_{IN} as the first designated sensitivity S1 (i.e., the original sensitivity). In addition, the threshold value generator 750 can be implemented by the threshold value generator 250 shown in FIG. 2, wherein the internal elements (i.e., the first measuring unit 752, the second measuring unit 754 and the threshold value generating unit 756) and related operations can be understood by referring to the descriptions above (please refer to FIG. 2, FIG. 4, and FIG. 5) and further description is omitted here for brevity.

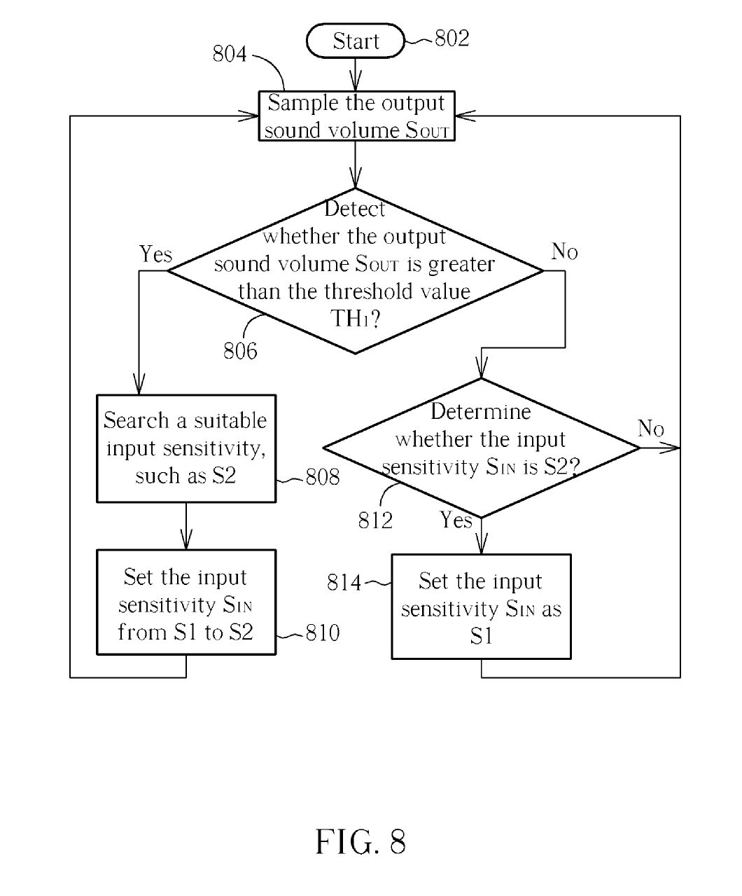

Please refer to FIG. 8. FIG. 8 is a flowchart illustrating a method for reducing echo according to another exemplary embodiment of the present invention. The method includes, but is not limited to, the following steps:

Step 802: Start;

Step 804: Sample the output sound volume S_{OUT};

Step 806: Detect whether the output sound volume S_{OUT} is greater than the threshold value TH₁. If the output sound volume S_{OUT} is detected to be greater than the threshold value TH₁, go to Step 808; otherwise, go to Step 812;

Step 808: Search a suitable input sensitivity, such as the second designated sensitivity S2;

Step 810: Set the input sensitivity S_{IN} from the first designated sensitivity S1 to the second designated sensitivity S2;

Step 812: Determine whether the input sensitivity S_{IN} is the second designated sensitivity S2. If the input sensitivity S_{IN} is determined to be the second designated sensitivity S2, go to Step 814; otherwise, go back to Step 804;

Step 814: Set the input sensitivity S_{IN} as the first designated sensitivity S1.

The following description details how each element operates by collocating the steps shown in FIG. 8 and the elements shown in FIG. 6 and FIG. 7. In Steps 804-806, the sound volume detecting module 720 samples the output sound volume S_{OUT} every period of time and detects whether the output sound volume S_{OUT} is greater than the threshold value TH₁. In the following, the steps in FIG. 8 are divided into two conditions for detail descriptions. Under the first condition, when the output sound volume S_{OUT} is greater than the threshold value TH₁, the sensitivity setting module 710 searches a suitable input sensitivity (such as the second designated sensitivity S2) and then sets the input sensitivity S_{IN} from the first designated sensitivity S1 to the second designated sensitivity S2 (Steps 808-810). Under the second condition, when the output sound volume S_{OUT} is not greater than the threshold value TH₁, the sensitivity detecting module 730 detects whether the input sensitivity S_{IN} is the second designated sensitivity S2 (Step 812). If the input sensitivity S_{IN} is the second designated sensitivity S2, the sensitivity setting module 710 then sets the input sensitivity S_{IN} as the first designated sensitivity S1 (Step 814); if the input sensitivity S_{IN} is not the second designated sensitivity S2, the sound volume detecting module 720 continues sampling the output sound volume S_{OUT} every period of time (return to Step 804).

It should be noted that the steps of the flowchart mentioned in FIG. 3, FIG. 5, and FIG. 8 above are merely practicable embodiments of the present invention, and should not be taken as limitations of the present invention. The method can include other intermediate steps or can merge several steps into a single step without departing from the spirit of the present invention.

The abovementioned embodiments are presented merely for describing the present invention, and in no way should be considered to be limitations of the scope of the present invention. From the above descriptions, the present invention provides methods for reducing echo and related echo reducing device and voice apparatus. Through detecting the output sound volume S_{OUT}, the input sensitivity S_{IN} of the sound input device can be dynamically adjusted to reduce echo. When the output sound volume S_{OUT} exceeds the predetermined maximum value (i.e., the threshold value TH₁), the mechanism is immediately started to adjust the input sensitivity S_{IN} to a suitable value to avoid echo. Please note that the sensitivity setting module can be implemented by a micro-processing control unit and the sound detecting module can be implemented by an analog-to-digital converter, wherein the analog-to-digital converter can be disposed outside or inside the micro-processing control unit. For operations of these apparatus and the differences between them, please refer to the descriptions detailed above. In addition, the echo reducing mechanism (including the device and method) disclosed in the present invention can be collocated with the conventional echo reducing technologies, such as hardware machinery, software calculation, and dedicated processing chip, which further improves the effect of reducing echo. Furthermore, the sound quality of a sound input device will not be seriously affected by adjusting the input sensitivity S_{IN}. Therefore, consumer electronic products can still maintain voice quality with full duplex, but echo can be greatly reduced, which is an economical and worthy solution.

Those skilled in the art will readily observe that numerous modifications and alterations of the device and method may be made while retaining the teachings of the invention.

What is claimed is:

1. A method for reducing echo, comprising:
detecting whether an output sound volume is greater than a threshold value; and
setting an input sensitivity from a first designated sensitivity value to a second designated sensitivity value when the output sound volume is detected to be greater than the threshold value.

2. The method of claim 1, further comprising:
detecting whether an interrupt signal is received;
determining whether the interrupt signal is triggered by detecting that the output sound volume is greater than the threshold value when receiving the interrupt signal;
detecting whether the input sensitivity is the second designated sensitivity value when determining that the interrupt signal is triggered by detecting that the output sound volume is greater than the threshold value; and
setting the input sensitivity as the second designated sensitivity value when detecting that the input sensitivity is not the second designated sensitivity value.

3. The method of claim 2, further comprising:
resetting a waiting time when determining that the input sensitivity is the second designated sensitivity value;
determining whether the interrupt signal is trigged by the waiting time being exceeded when determining that the interrupt signal is not triggered by detecting that the output sound volume is greater than the threshold value; and
setting the input sensitivity as the first designated sensitivity value when determining that the interrupt signal is triggered by the waiting time being exceeded.

4. The method of claim 1, further comprising:
detecting whether the input sensitivity is the second designated sensitivity when the output sound volume is detected to be not greater than the threshold value; and
setting the input sensitivity as the first designated sensitivity when the input sensitivity is detected to be the second designated sensitivity.

5. The method of claim 1, further comprising:
maintaining the input sensitivity at a fixed sensitivity, and measuring a first relationship between the output sound volume and an echo;
maintaining the output sound volume at a fixed sound volume, and measuring a second relationship between the input sensitivity and the echo; and
generating the threshold value according to the first relationship and the second relationship.

6. An echo reducing device, comprising:
a sound volume detecting module, for detecting whether an output sound volume is greater than a threshold value; and
a sensitivity setting module, coupled to the sound volume detecting module, for setting an input sensitivity from a first designated sensitivity value to a second designated sensitivity value when the output sound volume is detected to be greater than the threshold value.

7. The echo reducing device of claim 6, further comprising a judging module coupled between the sound volume detecting module and the sensitivity setting module, the judging module comprising:
an interrupt signal detecting unit, for detecting whether an interrupt signal is received;
an interrupt trigger determining unit, for determining whether the interrupt signal is triggered by detecting that the output sound volume is greater than the threshold value when receiving the interrupt signal, and for determining whether the interrupt signal is triggered by a waiting time being exceeded when determining that the interrupt signal is not triggered by detecting that the output sound volume is greater than the threshold value; and
a sensitivity detecting unit, for detecting whether the input sensitivity is the second designated sensitivity value when determining that the interrupt signal is triggered by detecting that the output sound volume is greater than the threshold value, and for resetting the waiting time when determining that the input sensitivity is the second designated sensitivity value.

8. The echo reducing device of claim 7, further comprising a time coupled to the sensitivity detecting unit for counting the waiting time.

9. The echo reducing device of claim 7, wherein the sensitivity setting module is further used for setting the input sensitivity as the first designated sensitivity value when determining that the interrupt signal is triggered by the waiting time being exceeded.

10. The echo reducing device of claim 6, further comprising a sensitivity detecting module coupled between the sound volume detecting module and the sensitivity setting module for detecting whether the input sensitivity is the second designated sensitivity when the output sound volume is detected to be not greater than the threshold value; and the sensitivity setting module is further used for setting the input sensitivity as the first designated sensitivity when the input sensitivity is detected to be the second designated sensitivity.

11. The echo reducing device of claim 6, further comprising a threshold value generator coupled to the sound volume detecting module, the threshold value generator comprising:
a first measuring unit, for maintaining the input sensitivity at a fixed sensitivity, and measuring a first relationship between the output sound volume and an echo;
a second measuring unit, for maintaining the output sound volume at a fixed sound volume, and measuring a second relationship between the input sensitivity and the echo; and
a threshold value generating unit, coupled to the first measuring unit and the second measuring unit, for generating the threshold value according to the first relationship and the second relationship.

12. The echo reducing device of claim 6, wherein:
the sensitivity setting module is a micro-processing control unit; and
the sound volume detecting module is an analog-to-digital converter.

13. The echo reducing device of claim 12, wherein the analog-to-digital converter is disposed outside the micro-processing control unit.

14. The echo reducing device of claim 12, wherein the analog-to-digital converter is disposed inside the micro-processing control unit.

15. A voice apparatus capable of reducing echo, the voice apparatus comprising:
a sound output module, for outputting an output sound volume;
a sound input module, having an input sensitivity;
a sound volume detecting module, for detecting whether the output sound volume is greater than a threshold value; and
a sensitivity setting module, coupled to the sound volume detecting module and the sound input module, for setting the input sensitivity of the sound input module from a first designated sensitivity value to a second designated sensitivity value when the output sound volume is detected to be greater than the threshold value.

16. The voice apparatus of claim 15, wherein the sound output module is a speaker.

17. The voice apparatus of claim 15, wherein the sound input module is a microphone.

18. The voice apparatus of claim 15, being a Bluetooth hands-free device.
